(19) United States
(12) Patent Application Publication
(10) Pub. No.: US 2019/0084644 A1
(43) Pub. Date: Mar. 21, 2019

(54) Assembly of bicycle frame, cassette, and wheel

(71) Applicant: Veselin Mandaric, San Marcos, CA (US)

(72) Inventor: Veselin Mandaric, San Marcos, CA (US)

(21) Appl. No.: 15/711,586

(22) Filed: Sep. 21, 2017

(51) Int. Cl. B62M 9/10

(52) U.S. Cl. CPC B62M 9/10

(57) ABSTRACT

The present invention is an assembly of bicycle frame, cassette, and wheel that improves the efficiency and performance of bicycle riding by placing the cassette on the frame and outside of the area between the left and right chain stays.

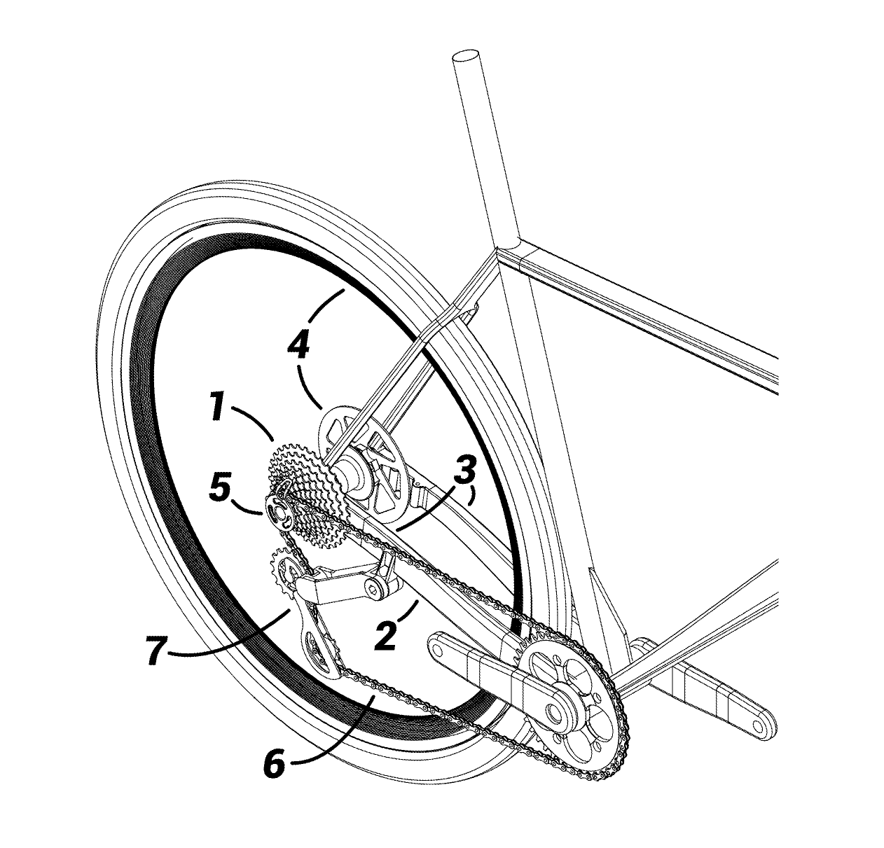

### BACKGROUND OF THE INVENTION

The present invention is directed towards a bicycle that provides a high-quality riding experience. The assembly of bicycle frame, cassette, and wheel is an area that can still be improved in order to provide the user a better ride.

### BRIEF SUMMARY OF THE INVENTION

The present invention is an assembly of bicycle frame, cassette, and wheel that improves the efficiency and performance of bicycle riding by placing the cassette on the frame and outside of the area between the left and right chain stays.

### BRIEF DESCRIPTION OF THE DRAWING

The drawing is a depiction of the assembly of bicycle frame, cassette, and wheel from a three-dimensional perspective.

### DETAILED DESCRIPTION OF THE INVENTION

In traditional bicycle manufacturing, the cassette is placed on the wheel hub and located between the left and right chain stays. When the wheel is removed from the frame, it is removed along with the cassette. Furthermore, removing the wheel is a tedious procedure because the chain must be removed from the cassette which is placed on the wheel.

In the present invention, these issues are addressed by placing the cassette on the frame so that it resides outside of the area between the left and right chain stays. This creates a more-efficient transmission of energy from the rider's legs to the spinning of the wheel.

Referring to the drawing, the cassette 1 is placed on the frame 2 and located outside of the area between the left and right chain stays 3. The wheel 4 resides between the left and right chain stays 3 and turns in reaction to the cassette 1 by means of an axle 5. The chain 6 runs through the rear derailleur 7 and then over the cassette 1.

What is claimed is:

1. (canceled)

2. A drive assembly for a bicycle comprising:
a bicycle frame including:
chainstays including:
a left chainstay having a rear end and a front end, and
a right chainstay having a rear end and a front end; there being an area between said chainstays;
an axle rotatably mounted on said chainstays toward the rear end of said chainstays;
a wheel mounted on said axle in the area between said chainstays;
a cassette surrounding said axle and rotatably mounted on one said chainstay toward the rear end of said chainstay and outside of the area between said chainstays;
said axle coupling said cassette to said wheel for turning said wheel responsive to the turning of said cassette.

3. The drive assembly of claim 2 further including:
a derailleur mounted to said frame forward of said cassette.
